(19) United States
(12) Patent Application Publication
(10) Pub. No.: US 2012/0000272 A1
(43) Pub. Date: Jan. 5, 2012

(54) Device for Controlling Leaks From an Endoscope

(76) Inventor: Francisco Santiago Soriano Romero, Barcelona (ES)

(21) Appl. No.: 13/148,571

(22) PCT Filed: Feb. 22, 2010
(86) PCT No.: PCT/IB10/00384

§ 371 Date: Sep. 19, 2011

(30) Foreign Application Priority Data
Feb. 10, 2009 (ES) P200900369

(51) Int. Cl. G01M 3/02

(52) U.S. Cl. 73/40

(57) ABSTRACT

The invention relates to a device for controlling leaks from an endoscope, connected to the operating segment at the proximal end of the endoscope. The invention is characterised in that it comprises: a connection valve (2) for connecting the device to the endoscope (1), said valve being connected to the end of a tubular external housing (3), the opposite end of which housing is provided with an internal piston (4), also tubular, the size and shape of which are such that it moves in a sealed manner inside the housing in a direction parallel to the axis (5) of rotation of the housing (3) and the actual piston (4), said piston (4) having a test line (7) perpendicular to the axis (5) of rotation thereof.

### OBJECT OF THE INVENTION

This application for an invention patent is comprised in the field of medicine, more specifically to the field of controlling the correct operation or testing of an endoscope. This control is focused on the detection of possible leaks from it.

### BACKGROUND TO THE INVENTION

At present, it is normal practice after the use of an endoscope in an exploration or an intervention by endoscopy, for the doctor to conduct a compulsory sealing test on the endoscope before using it again, to prevent any potential problems with leaking when it is used again.

Traditionally, this check or test is carried out using a conventional pressure gauge by pumping air or by suction, with a view to checking whether or not the pressure remains constant in time. Although this method is simple, there are several drawbacks, including the false leaks that take place owing to the deterioration of the pressure gauge tube, and the fact that it is difficult to read the pressure on the clock.

A large number of methods have subsequently been implemented to check whether endoscopes are sealed, some of which involve blowing a certain amount of air into the endoscope and submerging it in a tank full of fluid and checking if there are any leaks, these manifesting themselves in the form of bubbles inside the tank. Logically, this method requires the availability of such a tank, the drawback being that once the test has been conducted the endoscope has to be dried, which takes time.

Other systems are based on the insertion of complex electronic systems based on pressure detectors, which establish the pressure at different points inside the endoscope, comparing the measurements and establishing whether or not there are any leaks. These systems, apart from being extremely delicate and requiring careful handling, are also very costly.

In view of the above, a need has been detected to provide a very simple device that based on a simple housing and a piston, manages to quickly and rather cheaply establish whether or not there are any leaks inside the endoscope.

This aim is achieved with an invention that is defined in claim 1; in the subsequent claims, preferred embodiments of the invention are defined.

### DESCRIPTION OF THE INVENTION

This invention relates to a device for controlling leaks from an endoscope that is connected to the operating section of the endoscope at the proximal end thereof. Specifically, this device is characterised in that it contains a connection valve from the device to the endoscope, connecting said valve to the end of an outer tubular casing that is equipped with an interior piston at the opposite end, which is also tubular and whose size and shape are such that it moves inside the housing, running in a direction parallel to the axis of rotation of the housing and the actual piston, said piston having a test line perpendicular to the axis of rotation thereof, this line being located at a certain distance from the free end of the piston.

Thus, thanks to a very simple device, the user manages to determine whether or not there are leaks inside the endoscope, using the device in the following way.

First of all, the valve for the device is connected to one of the openings leading into the endoscope, the valve is closed rendering it sealed and once this is done the piston is moved with respect to the housing, in such a way that either a suction effect is caused extracting some of the air inside the endoscope or air is blown into the endoscope. This operation can be carried out one or more times depending on the relative size between the endoscope and the piston, that is to say, depending on the amount of volume of air that the device is able to drive in each particular case. Once certain pressure conditions have been reached inside the endoscope, the user will stop acting on the piston and will observe the test line. If its position has undergone any movement with respect to the position it was in when action on the piston ceased, this means that there is some type of leak in the endoscope. On the contrary, when the test line remains in its same position, this means that there is no leak at all and that the endoscope is ready to be used again. Therefore, the device that is the object of this invention, which is very simple in constitution, easy to handle and cheap to manufacture, enables its user to quickly find out whether or not there are any leaks in the endoscope.

### BRIEF DESCRIPTION OF THE DRAWINGS

FIG. 1 shows a view in perspective of the endoscope to which the device that is the object of the invention has been coupled.

FIG. 2 shows a view to a larger scale of the endoscope zone to which the device is connected, when the device is actually connected.

FIG. 3 shows a view in perspective of the device that is the object of this invention when it is idle.

FIG. 4 shows a view in perspective of the device that is the object of this invention when it is in an actuation position, exerting pressure on the piston.

### DESCRIPTION OF A PREFERRED EMBODIMENT

In view of the figures discussed and in accordance with the numbering adopted, a non-limiting preferred embodiment of the invention can be seen, consisting of a sensitive switch-button.

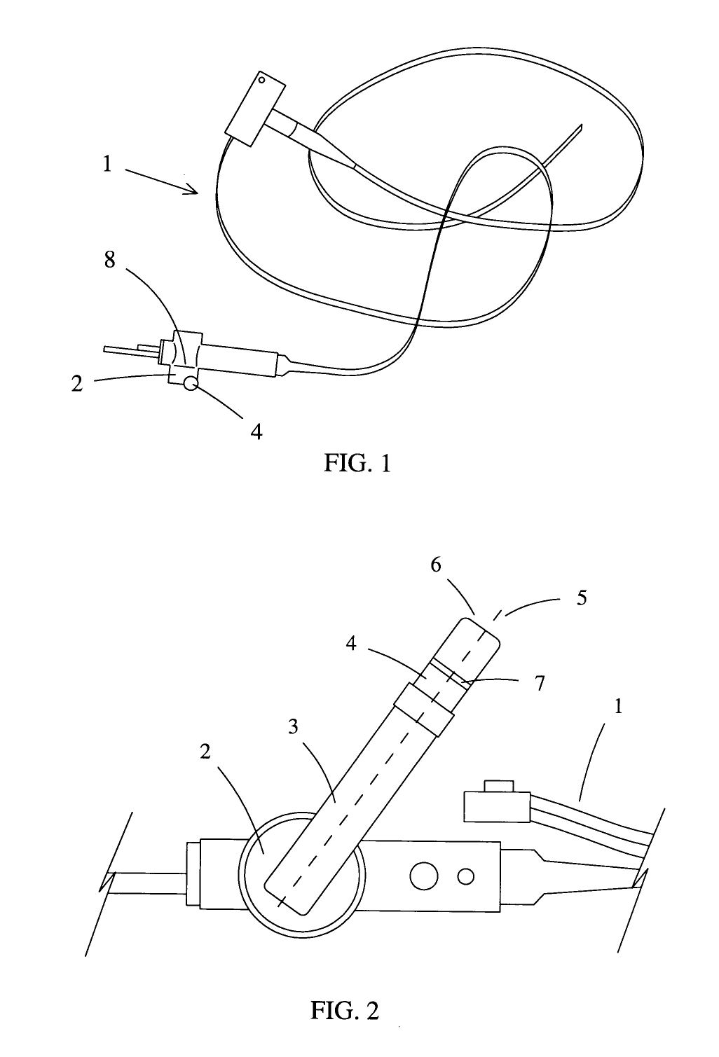

FIG. 1 shows a view in general perspective of an endoscope (1) to which the device that is the object of this invention is connected via a connection valve (2) to an outlet (8) on the endoscope located in its operating section.

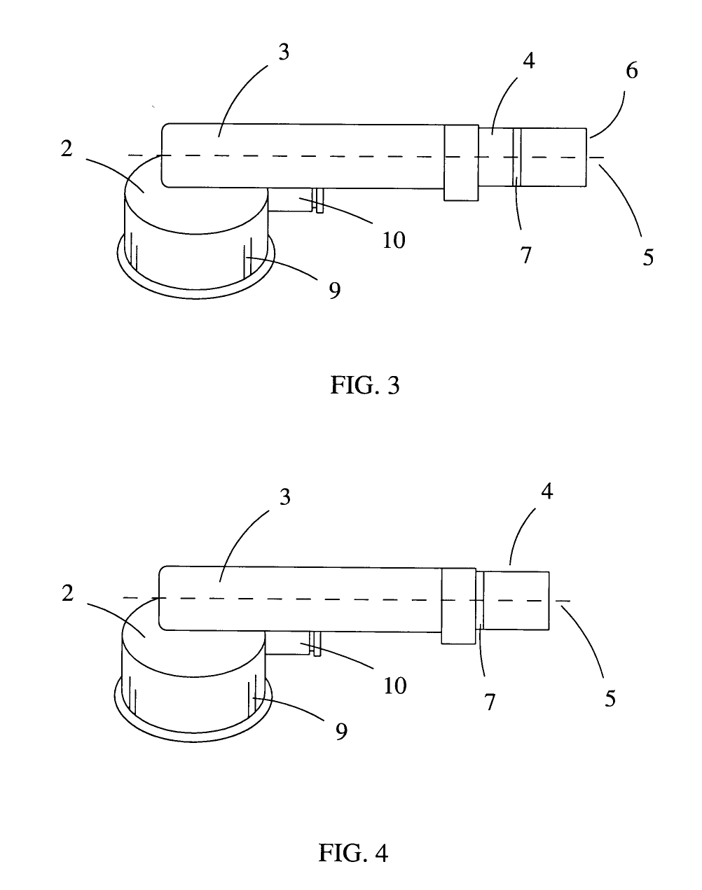

As can be seen in FIG. 3, for example, said connection valve (2) in this preferred embodiment, consists of a kind of circular nut, whose thread is on the interior, which is equipped with a series of ribs (9) arranged lengthways to facilitate the valve tightening and loosening, it also being equipped with a small stopcock (10) to expel the air from inside the endoscope.

The aforementioned connection valve (2) has connected to it in a sealed manner and perpendicular to its axis of rotation, an external tubular housing (3), which in this embodiment of the invention will be made of plastic that is highly resistant to pressure. Just inside said housing (3), the device is equipped with an inner piston (4) which is also tubular and fits in a perfectly sealed manner in said housing, it being able to move parallel to the axis (5) of rotation of said housing (3). At a certain distance from the free end (6) of the piston (4) there is a test line (7), which consists of a mark in a colour different from the piston (4) that is circular and perpendicular to the axis (5). The distance at which this test line (7) is calculated, depends in each case on the positive pressure (blowing) or negative pressure (suction) that the user wishes to obtain in the endoscope (1). The sealing between the piston (4) and the housing (3) will be achieved by inserting o-ring seals (not shown in the figures) outside the piston or inside the housing.

By use of the aforementioned piston (4) in its lengthwise movement with respect to the housing (3) and thanks to the stopcock (10), a certain amount of air from inside the endoscope can be expelled, thereby achieving a negative pressure or vacuum situation, or a positive pressure situation. Once such a situation has been reached, the user stops operating the piston and observes the displacement of the test line (7) to establish whether there are pressure losses and thus leaks in the endoscope. FIG. 4 shows the position of the piston (4) when it has reached the end of the piston run (3) with respect to the housing (4) when the user exerts a certain amount of pressure on it.

1. Device that controls the leaks from an endoscope that is connected to the operating section of the endoscope at the proximal end, comprising: a connection valve connecting the device to the endoscope the connection valve being connected to the end of an exterior tubular housing that is equipped on the opposite end with an interior piston, which is also tubular and whose size and shape are such that it moves inside the housing, running parallel to the axis of rotation of the housing and the actual piston in a sealed manner, the aforementioned piston being equipped with a test line perpendicular to the axis of rotation thereof.
